(19) United States
(12) Patent Application Publication
(10) Pub. No.: US 2006/0263559 A1
(43) Pub. Date: Nov. 23, 2006

(54) Method for creating variable prime label pressure sensitive web assemblies and prime label assembly produced therefrom

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/151,121

(22) Filed: Jun. 13, 2005

Related U.S. Application Data
(63) Continuation-in-part of application No. 11/135,481, filed on May 23, 2005.
(63) Continuation-in-part of application No. 11/135,131, filed on May 23, 2005.
(63) Continuation-in-part of application No. 11/135,179, filed on May 23, 2005.

(51) Int. Cl. B32B 33/00

(52) U.S. Cl. 428/40.1

(57) ABSTRACT

The present invention relates to the production of a prime label pressure sensitive laminate assembly. More particularly, the specification describes a process in which individual sheets are prepared by printing or imaging areas of the sheet with discrete indicia, preferably by using a high quality imaging device that produces graphical depictions on the surface of the sheet. The sheets are then cut or separated into prime label ribbons or segments, with each segment containing printing, and then the segments or ribbons are placed on a continuously advancing web to produce a web having discrete pre-printed ribbons or segments applied thereto. The laminated web may then be cut into individual sheets to create sheets that have one or more prime label ribbons disposed thereon.

### CROSS-REFERENCES TO RELATED APPLICATIONS

This application is a continuation-in-part of application Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference.

### FIELD OF THE INVENTION

The present invention is in the field of a method for manufacturing intermediate web assemblies to produce identifiers such as tags and labels that may be used in advertising, marketing, communications or for designating a source of a particular product or service. The subject of this application specifically includes a method of manufacturing prime labels from an intermediate pressure sensitive web construction and the article produced from that manufacture. The labels of the present invention are produced in part, initially from a pre-imaged or printed sheet and then converted or merged to a roll type of format and provided in one or more intermediate configurations to an end user. The sheets are printed with high quality graphics or images which are then slit or cut to size to form ribbons or label segments for the prime label application and then are converted to or merged with a continuously advancing web to create a continuous roll format, which may then be cut into sheets or shaped sheets. More particularly, the pressure sensitive laminates of the instant application can be used to create individual, prime labels having a high or even photo quality resolution level that is greater than about 150 lines per inch up to about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs in the prime label market. Conventional processes that are used today in creating prime labels are typically based on a continuous web technology using flexographic presses. The process includes the feeding of a continuous web of material, such as a preformed web of pressure sensitive laminate, which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the printing of decorative items, including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of about 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms, in cooperation with electronic scanners and image setters, to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing, due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators, which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as prime labels, using flexography may then be limited to serving only certain market segments, namely large market segments. Through the development of the present system and the creation of the unique intermediate web assembly described in this invention, the manufacture can now service a particular niche market segment for creating high quality templates in a continuous fashion, such as those ranging from approximately 100 to 1,000,000. While the foregoing market size or segment is a target area of the present invention, it should be appreciated that the invention may be practiced and used to fulfill larger order quantities, such as those of a million or more.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations and instead typically must occur through an off line operation, such as ink jetting, often after the label has been applied to the container or carton. Alternatively, the ink jetting may be performed directly on the container as part of a separate operation.

Flexographic presses normally have a number of pre-determined stations, for example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments such prime label products on consumer package goods (“CPG”), which may further enhance the product or service offering by making the product more attractive to prospective purchasers, thereby increasing the appeal to the consumer of the product or service.

Identifiers such as labels or tags may also be readily rendered using desktop equipment. While the resolution may be slightly improved when compared with conventional flexographic technology, speeds of application are significantly reduced as the images are processed in a sheet wise fashion on desktop equipment resulting in only a few sheets per minute as opposed to hundreds of feet per minute that are capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed therefore is a method by which high quality graphics for prime label applications, in excess of at least about 150 lines per inch can be produced in an efficient and cost effective manner, such as in a continuous system operating at greater than fifty feet per minute. Moreover, a method which can add substantial variability to the product as well as other features, such as embossments, over laminates, variable printing, additional elements or imaging and the like, would greatly expand the penetration of this form of business communication in the marketplace. The present invention seeks to provide a method for producing an innovative prime label intermediate having a quality of about 150 or more lines per inch and preferably more than 300 lines per inch, which is approximately equal to about 2500 to 3500 dots per inch (“DPI”), in order to create a high quality image that is intended to be aesthetically appealing to the consumer. The prime label intermediate may be cut into individual sheets or shaped sheets to further add to this unique offering.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality prime labels having significantly improved graphic resolution that is greater than at least about 150 lines per inch, preferably greater than about 200 lines per inch and still more preferably about 300 lines per inch, in an efficient and cost effective manner. The development of the present system, process and the creation of the unique intermediate web assembly described in this invention permit the servicing of a particular niche market segment for prime labels, that of approximately 100 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique sheet to roll process which provides savings when compared with conventional flexography process, specifically through reduced make ready time and generation of waste material and yields a higher image resolution product. The present invention uses previously prepared individually created sheets, or segments, that have imaging or printing already applied to the sheets, e.g. graphical depictions, before the sheets are provided to the manufacturing press. The sheets, ribbons or segments may be applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment of the present invention, a method for creating a variable prime label pressure sensitive laminate assembly is described and includes the steps of initially producing a plurality of individual sheets with each of the sheets having distinct areas printed with graphical depictions that are provided on at least one face of each of the sheets. The graphical depictions may be pictorial, miscellaneous designs and may include textual representations as well. Ideally, the graphical depictions will be of relatively high quality or resolution and may be printed on one side (top or bottom) or on both sides or faces of the laminate depending on the needs of the end user or job that is being produced.

Next, a continuous web, preferably a cellulosic based material, is advanced that has first and second faces and first and second longitudinally extending sides. The web is provided with a coating of release material, such as silicone, that is applied over the first face. A pattern of adhesive is then applied over the release coating and preferably not outside the perimeter or edges of the release coating. Each of the sheets is trimmed or cut to create a ribbon with at least one prime label segment, and discrete printed portion in the area of the ribbon with each prime label segment containing a graphical depiction. Each segment has a matrix portion and a prime label portion. As will be described herein in detail, the matrix portion is removed.

Each segment is then placed on the pattern of adhesive in a substantially abutting edge-to-edge relationship and between the first and second longitudinally extending sides of the continuous web. The web with the segments applied thereto is then cut into individual sheets with each sheet having at least one prime label segment. Then the sheets are advanced and collected in to a stack or other arrangement for use by the end user customer or application.

In a still further embodiment of the present invention, a method for creating a variable prime label pressure sensitive laminate assembly, is described and includes the steps of initially printing a number of individual sheets with textual and graphical depictions. Then each of the sheets are cut into discrete ribbons, with each ribbon having textual and graphical depictions from the sheet and each ribbon having a matrix portion and a prime label portion. A group of the ribbons is collected and placed into a mechanical feeder for disposition on a continuous web as will be later described herein. Next, a continuous web is advanced in a machine direction. The web has a pattern of adhesive applied over a release coating. Each of the ribbons is applied to the web and placed in contact with the adhesive, so that the ribbons are secured to the web as the web advances. Finally, an additional element is associated with or placed on each of the ribbons. At least one additional element may be added to the prime label portion, or alternatively, more than one element may be placed on the web. The additional element is selected from a group that includes cards, coins, tags, piggy back labels, micro chips, laminates and combinations thereof. Then the web with the ribbons is collected such as by rewinding, sheeting, fan folding or other acceptable or known means in the industry.

The embodiments disclosed in the present application also include the pressure sensitive laminate that is produced using one or more of the exemplary methods in carrying out the present invention.

The processes described above may also include a number of ancillary steps the application of coatings or films to one or both sides of the pressure sensitive laminate as well as the printing of personalized or variable indicia on the sheets, segments or web.

The processes may also include steps of verifying the placement or accuracy of the label segments or ribbons or the additional element if something is placed on top of the segment or ribbon. If the additional element is, for example, an RFID tag, the process would include a step of verifying the readability of the tag.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a block diagram of one exemplary method of practicing the present invention;

FIG. 2 shows a further block diagram of another exemplary process of practicing the present invention;

FIG. 3 illustrates a pressure sensitive prime label web as prepared in connection with the present invention;

FIG. 4 provides a cross sectional view of a prime label pressure sensitive laminate prepared in connection with the present invention, including the addition of a further element that has been placed on top of the prime label intermediate; and

FIG. 5 shows a shaped prime label sheet prepared in connection with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or for enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″11″, 11″×14″, 19″×25″ and other known sheet sizes or may be segments, divisions, strips, etc. of such sheets. For example, a 19″×25 sheet may be produced with five rows of labels, with each row having six labels, with each label having dimensions of approximately 3″×4″. For instance, in this example, each row may comprise an individual segment or sheet that may be used in practicing the present invention. It should, however, be understood that the invention is not to be so limited to the foregoing configuration that individual pieces or elements, regardless whether the piece or elements have a regular or irregular shape, may be used in connection with this process to produce the intermediate assembly that is described in this application.

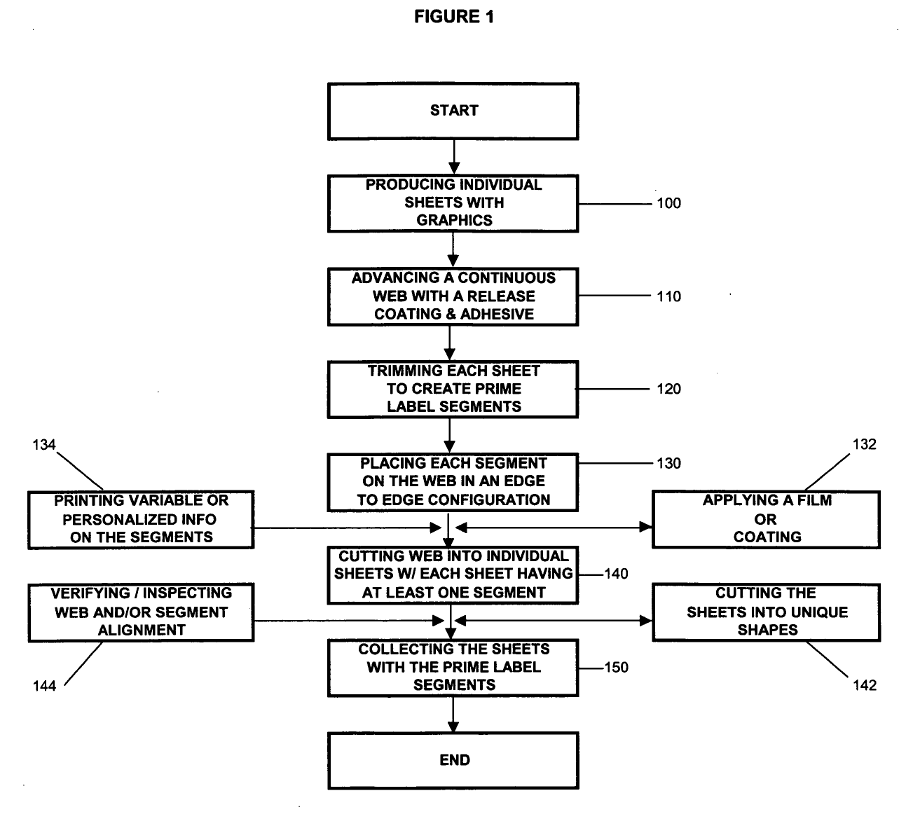

Turning now to FIG. 1 of the present invention, a block diagram showing an exemplary method of practicing the invention is presented. The process is begun as represented by the box entitled “start’ and includes the preparation of a number of sheets that have images rendered on one or both faces at step 100. The base stock or sheets that are prepared in accordance with the present invention is provided in one of any standard sheet formats that may be used by a high resolution imaging device such as Indigo®, available from Hewlett Packard of Palo Alto, Calif. or Karat available from KBA of Williston, Vt. The present invention seeks to provide a prime label segment or intermediate that has a quality of at least about 150 or more lines per inch and preferably more than 300 lines per inch, which is approximately equal to about 2500 to 3500 dots per inch (“DPI”) in order to create a high quality image that is intended to be aesthetically appealing to the consumer.

In the present exemplary method, the standard sheet size may be approximately 19″×25″ and a number of label segments can be produced from the sheet. For example, each segment may have six labels. Each of the labels in this example has a dimension of approximately 2.875″4″. It should be understood that any standard label size might be produced as well as odd sized labels or labels having different configurations or shapes.

Continuing with a description of the present invention, a continuous web is advanced at step 110. The web is provided with a coating of a release material such as silicone which is then over coated with a pattern of adhesive. The release and adhesive are preferably provided between the longitudinally extending sides of the continuous and generally centrally thereof.

Each of the sheets that were prepared in step 100 are then trimmed or cut into individual label segments or ribbons at step 120. Each of the ribbons or segments has a matrix area and a prime label portion on which the graphical depiction(s), text and other imaging is provided. Each sheet will preferably be cut into multiple segments or ribbons, but it should be understood that each sheet may only have one ribbon or segment cut from the sheet. Selection of the number of sheets will be job or application specific.

Each segment is then placed on the web in an edge-to-edge arrangement at step 130. An edge-to-edge arrangement, as used herein, includes an abutting relationship, a slightly spaced or overlapping relationship of the segments or ribbons. The adhesive that has been previously provided on the web is used to hold the segments or ribbons in place and will serve as the adhesive that will be used to secure the label to the container, receptacle or the like.

Once the label segments or ribbons have been added to the web, the web is advanced to a cutting station at step 140 where the laminate (web with segments applied thereto) is cut into individual sheets, with each sheet having at least one prime label segment. Finally, at step 150 the sheets are collected in a stack or in a sheet wise fashion.

The presently described embodiment may also include several additional processing steps, but it should be understood that the additional processing steps may or may not be used depending on the requirements of the application or job. For example, one may wish to apply a supplementary coating, such as a film, coating or varnish at step 132, or create an additional laminated assembly with the addition of a synthetic film over the top of the web and segment. In addition, one may elect to add personalized or variable information at step 134. Such personalization may include indicia selected from demographic databases, names, promotions, coding and such other information or printing that may be particularly desirable.

Additional steps may include the cutting of the sheets at step 142 into sheets having unique shapes, such as may be selected from animate, inanimate, geographic and combinations thereof. The process may also include the step of verifying and/or inspecting the web at step 144. This step may include ensuring proper alignment of the label segments with the pattern of adhesive and direction of web travel, any exposed adhesive areas that would need to be deadened, or if ancillary elements are added, such as a RFID tag, that the tag still “reads” upon exiting the process.

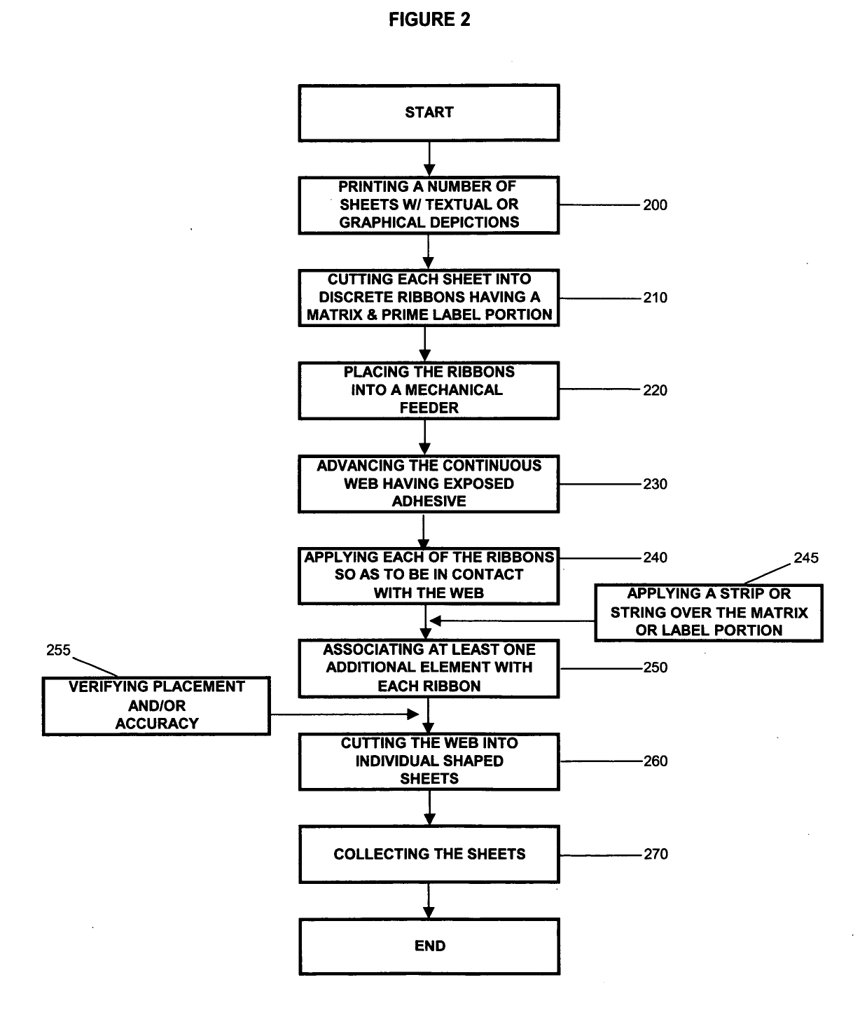

Turning now to FIG. 2, in which a further exemplary process of carrying out the invention is depicted. The process includes a first step 200 where a number of sheets are pre-printed or imaged with indicia or graphics relating to an order or a particular job for an end user. Each of the sheets are then cut at step 210 into individual or discrete ribbons or segments with each ribbon having a matrix portion and a prime label portion which is the area where the indicia has been applied or printed.

The ribbons are then collected at step 220 and are placed into a mechanical feeder for processing and addition to the web. Next, the web is advanced at step 230. The web has been previously provided with a coating of release material and pattern of adhesive that is applied over the release. The continuous web is preferably selected from a highly calendared, cellulosic based stock. The release coating is provided on the first face of the web such that when an adhesive is applied, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

The ribbons that were collected for the mechanical feeder at step 220 are then applied to the web at step 240 so that the ribbons contact and are adhered to the web. Next, the web is again advanced and an additional element is applied to the top of the prime label segment at step 250. An exemplary placer, feeder or insertion device such as a Mavericks is available from In-Line Automation of Minneapolis, Minn. The feeder may be used for placing the label segments as well as the additional items. The additional items are selected from a group including cards, coins, tags, piggy back labels, micro chips, laminates and combinations thereof. The prime label portion may be provided with only one additional element or may be provided with multiple elements depending on the requirements of the particular job or order.

Next, the web with the prime label segments is cut at step 260 into individual sheets with each sheet having at least one segment applied thereto. The sheets are then collected at step 270 in one of several possible formats, including stacks.

The present exemplary process may be practiced with one or more additional steps, including step 245, which includes the application of a string or strip of tape that temporarily holds the segments together. The string or strip of tape is preferably provided in the matrix portion of the segment but may also be provided so as to connect the prime label portions one to another. In the former, when the matrix is removed from the prime label portion, the string or strip of tape is taken up along with the matrix. In the latter, the string will be broken when the labels are separated from the sheet to which they are temporarily mounted.

The foregoing process may also include a step of verifying the placement and/or accuracy of the label segments and/or additional elements at step 255. This may be accomplished through the use of electronic eyes or other vision systems as are known in the art.

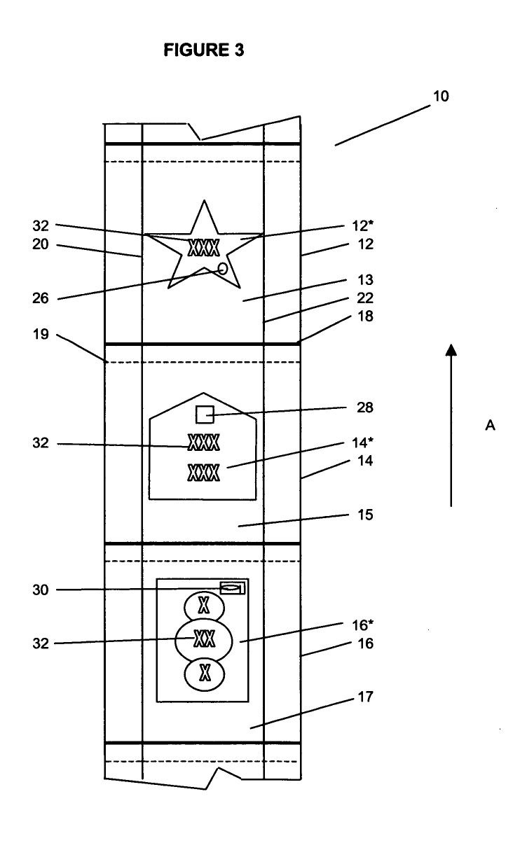

FIG. 3 shows an exemplary web prepared in accordance with the present invention. The web is generally depicted by reference to numeral 10 and is shown traveling in a machine direction represented by the letter “A”. The web 10 as shown has a series of label ribbons or segments 12, 14 and 16. Each segment is provided with a matrix portion 13, 15 and 17, respectively and a prime label portions 12*, 14* and 16*, respectively.

The label segments are shown in an overlapping configuration where the trailing edge 19 of label segment 12 is beneath the leading edge 18 of the successive label segment 14. The production of the prime label intermediate web assembly prepared in accordance with the present invention creates an intermediate web assembly that has intermittent laminations. That is, portions of the prime label segments are adhered to the web and smaller portions, such as the edges, may be free of adherence due to a slight overlap between successive prime labels segments disposed on the web. The overlap is preferably less than one inch (1″), more preferably less than one half of one inch (½″) and still more preferably less than about one thirty second of an inch ( 1/32″) and still yet more preferably less than about one sixty fourth of an inch ( 1/64″). The overlap may be created to facilitate the placing of sheets on the web and accommodates slight changes in timing that may occur due to web or placer mechanism speed. It should be understood that it may not be necessary to create an overlap and the sheets may be laid edge-to-edge or alternatively the sheets may be spaced from one another along the web. In this latter configuration, the adhesive, if exposed may be deadened by application of radiation, over coatings or the like.

The label ribbons are shown held in alignment through the use of strings 20 and 22 which will ensure alignment of the ribbons or segments with the web as the web advances through additional processing stations. The string will preferably be applied in the matrix area of each of the label segments so that when the matrix is peeled away after die cutting of the prime label portion from the matrix the string will also be pulled off and collected with the matrix material.

FIG. 3 also shows the addition of another element referenced by numerals 26, 28 and 30. Item 26 is a circular disc, such as a coin, 28 may be a piggy back label and 30 may be a RFID tag. The additional elements may be selected from a larger group including cards, coins, tags, piggy back labels, micro chips, laminates and combinations thereof. The prime label portions are provided with graphics, text and other printing which is represented by numeral 32.

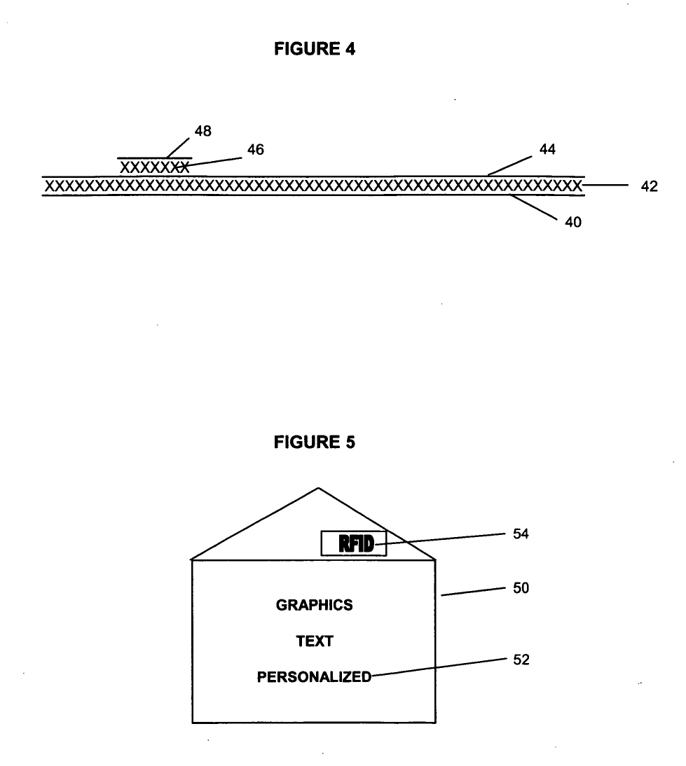

Reference is now directed to FIG. 4 which presents a cross-sectional view of a portion of the prime label laminate assembly of the present invention. As previously discussed there is a carrier or continuous web represented by numeral 40 which is provided with a pattern of adhesive 42 over a layer of release material (not shown). The prime label ribbons or segments 44 are applied over the adhesive and will be held in adhesive association with the carrier web until the prime label ribbon is subsequently removed from the web. Adhesive 46 may be used to hold an additional element 48 as discussed in connection with FIG. 4 to the surface of the prime label segment 44.

FIG. 5 shows the prime label pressure sensitive laminate assembly cut into a shaped sheet format, here represented by a house shape 50. Also shown in FIG. 5, the prime label has been provided with personalization, graphical depictions and text 52 as represented by wording to that effect. In addition, the prime label sheet portion also has an additional element 54 affixed to the surface of the prime label portion.

Through use of the present invention, a vast array of identifiers, e.g. labels, tags, cards, plates, etc. can be placed on an adhesive coated web and then collected for later use, thereby creating a versatile pressure sensitive intermediate web assembly. Through the use of the foregoing process, a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional label applicators.

The present invention further fulfills the need of the small to medium range market for prime labels, those quantities typically between 100 and 1,000,000 without requiring the payment of substantial premiums as may be necessary to offset the costs associated with traditional processes such as flexographic technology.

It will thus be seen according to the present invention a highly advantageous system and method for creating a variable prime label pressure sensitive laminate assembly has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method for creating a variable prime label pressure sensitive label laminate assembly, comprising the steps of;
producing a plurality of individual sheets with areas having distinct graphical depictions provided on at least one face of each of said sheets;
advancing a continuous web having first and second faces and first and second longitudinally extending sides, a release coating is applied over said first face and a pattern of adhesive is applied over said release coating;
trimming each of said sheets to create at least one prime label segment from each sheet with each segment containing said distinct graphical depiction;
placing each segment on said pattern of adhesive in a substantially abutting edge-to-edge relationship and between said first and second longitudinally extending sides of said continuous web;
cutting said web with said segments into individual sheets with each sheet having at least one prime label segment; and
collecting said sheets with said prime label segment.

2. A method as recited in claim 1, wherein said step of cutting includes cutting said sheet into a shape selected from a group including geometric, animate, inanimate and combinations thereof.

3. A method as recited in claim 1, including a further step of applying a synthetic film over each of said prime label segments after the step of placing each segment on said web.

4. A method as recited in claim 1, including a further step of applying a coating over said prime label segments after the step of placing each segment on said web.

5. A method as recited in claim 1, including a further step of applying variable printing or personalization to said prime label segments after the step of placing each segment on said web.

6. A method as recited in claim 1, wherein said prime label segment includes an RFID tag.

7. A method as recited in claim 6, including a further step of reading said prime label segment with said RFID tag to confirm viability of said RFID tag.

8. A method as recited in claim 1, wherein said prime label segment includes at least one additional element selected from a group including cards, coins, tags, piggy back labels, micro chips, laminates and combinations thereof.

9. A method as recited in claim 1, wherein said graphical depictions are produced with a resolution of at least about 150 lines per inch.

10. A method as recited in claim 1, including a further step of verifying placement of each of said segments on said web prior to the step of collecting said sheets with said prime label segment.

11. A method for creating a variable prime label pressure sensitive prime label laminate assembly, comprising the steps of;
printing a number of areas on individual sheets with distinct textual and graphical depictions;
cutting each of said sheets into discrete ribbons, with each ribbon including at least one area, each ribbon having said distinct textual and graphical depictions from said sheet and each ribbon having a matrix portion and a prime label portion;
placing a group of said ribbons into a mechanical feeder;
advancing a continuous web, said web having a pattern of adhesive applied over a release coating;
applying each of said ribbons to said web and in contact with said adhesive;
associating at least one additional element with each of said ribbons; and
collecting said web with said ribbons.

12. A method as recited in claim 10, wherein said additional elements are selected from a group including RFID tags, cards, coins, tags, piggy back labels, micro chips, laminates and combinations thereof.

13. A method as recited in claim 10, including a further step of cutting said web into individual sheets after the step of associating additional elements with said ribbons to create discrete sheets with each sheet having at least one ribbon applied thereto.

14. A method as recited in claim 10, including a further step of cutting said web into individual shaped sheets after the step of associating additional elements with said ribbons to create discrete shaped sheets with each sheet having at least one ribbon applied thereto and said shaped sheets selected from a group including geometric, animate, inanimate and combinations thereof.

15. A method as recited in claim 10, including a further step of verifying placement of said ribbon and said additional element after the step of associating additional elements with said ribbons

16. A method as recited in claim 10, including a further step of applying a string or strip to one of said matrix portion or said prime label portion to hold said ribbons in alignment on said web after the step of applying each of said ribbons to said web and in contact with said adhesive.

17. A method as recited in claim 10, including a further step of detecting any exposed adhesive after the step of applying each of said ribbons to said web and in contact with said adhesive.

18. A prime label pressure sensitive laminate assembly produced in accordance with the method of claim 1.

19. A prime label pressure sensitive laminate assembly as recited in claim 18, wherein said prime label segment includes at least one additional element selected from a group including cards, coins, tags, piggy back labels, micro chips, laminates and combinations thereof.

20. A prime label pressure sensitive laminate assembly as recited in claim 18, wherein said sheet into a shape selected from a group including geometric, animate, inanimate and combinations thereof.
